(19) United States
(12) Patent Application Publication
(10) Pub. No.: US 2006/0072380 A1
(43) Pub. Date: Apr. 6, 2006

(54) Library control system and library device control method

(75) Inventors: Masakazu Fujiwara, Kato (JP); Hiroshi Fujiwara, Kato (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/026,152

(22) Filed: Jan. 3, 2005

(30) Foreign Application Priority Data
Sep. 22, 2004 (JP) 2004-275617

(51) Int. Cl. G11B 21/08

(52) U.S. Cl. 369/30.01

(57) ABSTRACT

A library control system includes a library device for storing plural recording media, plural host devices for requesting for an access to the recording media, and a channel switch device for controlling connection between the host device and the library device. The library device has plural drive units and a carriage unit for carrying a recording medium. The channel switch device has a logic switch for connecting plural host devices and plural drive units in accordance with a predetermined zone map, and a zone manager for setting the zone map. Each of the host devices has a zone controller for requesting the zone manager to set a zone map each time an access request is sent from the controller. The zone manager sets a zone map so that one of the plural drive units and one of the plural host devices belong to one zone and another host device does not belong to the zone to which the one drive unit and the one host device already belong.

### CROSS-REFERENCE TO RELATED APPLICATION

This application is related to Japanese application No. 2004-275617 filed on Sep. 22, 2004, whose priority is claimed under 35 USC § 119, the disclosure of which is incorporated by reference in its entirety.

### BACKGROUND OF THE INVENTION

1. Field of the Invention

The invention relates to a library control system, in particular, a library control system in which a library device storing plural storage media is connected to plural host devices and exclusive control is performed by preventing simultaneous accesses from plural host devices to the same drive unit mounted on the library device.

2. Description of the Related Art

Conventionally, there is a system in which a number of computer terminals and a storage shared by the terminals are connected via a network and an illegal access to the storage is prevented (for example, Japanese Unexamined Patent Publication No. Hei 10(1998)-333839).

For example, there is a library system in which a magnetic tape library device (hereinafter, referred to as “library device”) storing a number of magnetic tape media, and a number of high-order devices (hereinafter, referred to as “host devices”) using information stored in the media are connected to each other.

In the system, hitherto, the library device and the host devices are connected to each other by using an electric channel interface such as SCSI (Small Computer System Interface).

Generally, an interface such as SCSI of a type of directly connecting one of drive units mounted on the library device to one host device on a single bus is mainstream.

FIG. 9 is a configuration block diagram of a conventional library system. The diagram shows the case where host devices (H1, H2) 11 and drive units (D1, D2) 21 are connected to each other via SCSI interfaces (I/F) 13.

The host device H1 is directly connected to the drive unit D1 and the host device H2 is directly connected to the drive unit D2 by using different cables.

A library device 20 houses a number of media 23 and inserts a requested medium 23 into the drive unit 21, thereby realizing sharing of the media by the number of host devices.

A robot unit 22 takes out a requested medium 23, carries it to the drive unit 21, and sets it so that data can be read/written from/to the medium 23.

The drive unit 21 records/reproduces data to/from the set medium, and an instruction of recording/reproduction is given only from the host device 11 connected via the SCSI interface 13. A library controller 24 controls the robot unit 22 on the basis of the instruction from the host device 11.

The host device 11 is a so-called high-order device such as a personal computer or a workstation, transfers information to be recorded to the library device 20, and obtains information to be reproduced from the library device 20.

In such a library system, for example, when a data recording request from the host device H1 is sent to the library controller 24, the library controller 24 gives an instruction of setting the medium 23 to be recorded into the drive unit D1 directly connected to the host device H1 to the robot unit 22.

When the robot unit 22 carries the instructed medium 23 to the drive unit D1 and sets it into the drive unit D1, the host device H1 becomes able to record data onto the medium set in the drive unit D1.

In the system, all of media stored in the library device 20 can be shared. However, the host device 11 and the drive unit 21 are directly connected to each other in a one-to-one corresponding manner. Consequently, it cannot be always said that the drive unit 21 is effectively used.

Specifically, when the number of host devices 11 is “n”, “n” drive units 21 are necessary. That is, even when the k-th drive unit is not used, the host devices 11 other than the k-th host device cannot use the k-th drive unit 21. Therefore, it cannot be said that the resources are always effectively utilized from the viewpoint of usage rate of temporarily using all of the drive units.

Conventionally, as an electric channel interface, a connection form called multi-initiator connection is also employed.

The multi-initiator connection is a form that plural host devices 11 and plural drive units 21 are connected on a single bus and one host device can use an arbitrary drive unit 21.

In the form, the host device can use the arbitrary drive unit 21, so that the usage rate of the drive units 21 can be improved. However, since all of the host devices 11 and the drive units 21 are physically connected on a single bus, while a host device (H1) is using the drive unit (D1), another host device (H2) can access the medium 23 set in the drive unit (D1). Therefore, the case where exclusive control is insufficient can occur.

Normally, exclusive control is performed so that plural host devices 11 do not access the same drive unit 21 at the same time. However, due to an operation error of the user of the host device or an erroneous operation of a program loaded on the host device, the plural host devices 11 may access the same drive unit 21 at the same time. Due to unintentional data overwriting or the like, there is a case that data is lost or destroyed.

Further, in recent years, an optical channel interface which enables a multipoint-to-multipoint connection called a fiber channel as disclosed in Japanese Unexamined Patent Publication No. Hei 10(1998)-333839 is employed. By using the fiber channel, plural host devices 11 and plural drive units 21 can be connected to each other efficiently.

FIG. 10 is a configuration block diagram of a library system using a channel switch device as a component of a conventional fiber channel.

A channel switch device 30 has a zone manager 31 and controls connection between the host devices 11 and the drive units 21. The zone manager 31 is a part in which the connection relations between the host devices 11 and the drive units 21 are fixedly set in advance by an operation input of the user before startup of the system.

In the channel switch device 30, all of physical paths connecting ports of the host devices 11 and the drive units 21 are assured. By the zone manager 31, connections intended by the user are fixedly set.

For example, according to instruction inputs of the user, a fiber channel F1 of the host device H1 and a fiber channel F4 of the drive unit D1 are connected to each other, and fiber channels F2 and F3 of the host devices H2 and H3 are connected to a fiber channel F5 of the drive unit D2.

In such a fiber channel connection, the same drive unit (for example, D2) can be connected to plural host devices (for example, H2 and H3), thereby enabling the drive unit 21 to be effectively used.

In the fiber channel connection form of FIG. 10 as well, however, when there are plural host devices 11 which can be connected to the same drive unit 21, exclusive control has to be performed so that the plural host devices 11 do not access the drive unit 21 at the same time. In other words, also in the fiber channel connection, the same drive unit can be accessed at the same time due to an erroneous operation of a program of the host device or the like and there is a risk that data is destroyed. It cannot be said that security is sufficient.

Conventionally, the connecting relations between the host devices 11 and the drive units 21 are fixedly set in advance. Consequently, when there is an addition, deletion, change, or the like in the host devices or drive units, the user has to perform resetting.

The channel switch device 30 receives an access instruction from the host device 11 and performs control on the library device 20. There are various access instructions.

Various application programs which are loaded on a host device exist and there are various versions for the same program. For example, there are an application program using a drive unit reserve instruction and a drive unit release instruction and an application program which does not use such instructions.

In a state where such various application programs exist, when the host device H1 uses the drive unit 21 without using the reserve instruction, the drive unit 21 is not reserved, so that another host device H2 can directly access the same drive unit 21.

That is, exclusive control is not sufficient, so that loss of data cannot be perfectly prevented.

In the case where a host device 11 issues the reserve instruction and exclusively uses the drive unit 21, if a situation occurs such that the host device 11 becomes down and the release instruction cannot be issued, the drive unit 21 itself has to be recovered (or restarted). There is a case such that another connection between a host device and a drive unit, which is normally connected to the channel switch device 30 is also reset. The adverse influence is exerted on the whole library system.

Further, as the use of a fiber channel connection increases in recent years, the number of host devices 11 and the number of drive units 21 connected to the channel switch device 30 are also increasing. Therefore, effective use of the drive units 21 which are shared more and more in future and improvement in security such as exclusive control for preventing data loss or destruction are demanded.

### SUMMARY OF THE INVENTION

In general, in one aspect, the present invention relates to a library control system with improved security in the case of sharing a library device by plural host devices by dynamically determining connection between host devices and drive units as necessary while considering an aspect of utilization between host devices.

In general, in one aspect, the present invention relates to a library control system comprising a library device for storing plural recording media, plural host devices for requesting for an access to the recording media, and a channel switch device for controlling connection between the plural host devices and the library device, wherein the library device has plural drive units for accessing a mounted recording medium and a carriage unit for carrying a requested recording medium to a desired drive unit; the channel switch device has a logic switch for connecting the plural host devices and the plural drive units in accordance with a predetermined zone map, and a zone manager for setting the zone map; each of the plural host devices has a controller for transmitting a request of access to the library device, and a zone controller for requesting the zone manager to set a zone map each time the access request is sent from the controller; and when the zone controller requests the zone manager to set a zone map, the zone manager sets a zone map so that one of the plural drive units and one of the plural host devices belong to one zone and another host device does not belong to the zone to which the one drive unit and the one host device already belong.

Preferably, each of the host devices further has an inter-host communicator for performing periodic communication with other host devices, and wherein in case where two of the plural host devices (H1 and H2) are connected to the channel switch device, a first host device H1 has already accessed a recording medium mounted on a drive unit D1 in the library device, and the zone manager sets a zone map to which the first host device H1 and the drive unit D1 being accessed belong, when the inter-host communicator of a second host device H2 detects that the first host device H1 is in an interrupted state, the zone controller of the second host device H2 sends a request for releasing the zone map to the zone manager, and the controller sends a request for releasing the recording medium from the drive unit D1 included in the zone map to the carriage unit.

Preferably, in the case where the zone manager set a zone including only a first drive unit and a first host device, even when an access request to the first drive unit is received from a host device other than the first host device, the logic switch rejects the access request.

Preferably, the zone manager initially sets a zone map so that only one drive unit is included in one zone.

Preferably, the request for releasing the zone map is a zone switch instruction for switching the first host device H1 to the second host device H2 in the zone including the first host device H1.

In general, in one aspect, the present invention relates to a library control system comprising plural host devices for requesting for an access to a library device storing plural drive units for accessing a mounted recording medium and a channel switch device for controlling connection between the plural host devices and the library device, wherein the channel switch device has a logic switch for connecting the plural host devices and the plural drive units in accordance with a predetermined zone map, and a zone manager for setting the zone map; at least one of the plural host devices has a controller for transmitting a request of access to the library device, and a zone controller for requesting the zone manager to set a zone map each time the access request is received from the controller; and wherein when one of the plural host devices requests for an access to the library device, a zone map is set so that one of the plural drive units and the one of the plural host devices belong to one zone and another host device does not belong to the zone to which the one drive unit and the one host device already belong.

In general, in one aspect, the present invention relates to a library device control method of a library control system comprising a library device, plural host devices for requesting for an access to the library device storing plural drive units for accessing a mounted recording medium and a channel switch device for controlling connection between the plural host devices and the library device, wherein when one of the host devices requests for an access to the library device, the channel switch device accepts the access request and, after that, a zone map is set so that one of the plural drive unit and the one of the plural host devices belong to one zone and another host device does not belong to the zone to which the one drive unit and the one host device already belong.

The library control system of the invention controls connection between plural host devices and plural drive units provided in the library device, and utilizes the channel switch device for the connection control.

The host device and the channel switch device are physically connected to each other via a predetermined cable. The predetermined cable is, for example, a fiber channel cable.

The physical connection between the drive unit and the channel switch device is also made via a similar cable. The carriage unit denotes a so-called robot unit which moves between a storage for housing a recording medium and a drive unit to carry a recording medium.

### BRIEF DESCRIPTION OF THE DRAWINGS

FIG. 1 is a configuration block diagram showing an embodiment of a library control system of the invention;

FIG. 2 is an explanatory diagram of zone setting of the embodiment of the library control system of the invention;

FIG. 3 is an explanatory diagram of zone management information of the library control system of the invention;

FIG. 4 is an explanatory diagram showing a zone map state of the library control system of the invention;

FIG. 5 is a flowchart showing process of accessing a library device of the invention;

FIG. 6 is an explanatory diagram showing the flow of process of accessing the library device of the invention;

FIG. 7 is a configuration block diagram showing another embodiment of the library control system of the invention;

FIG. 8 is an explanatory diagram showing the flow of a zone switching process of the invention;

FIG. 9 is a configuration block diagram of a conventional library system; and

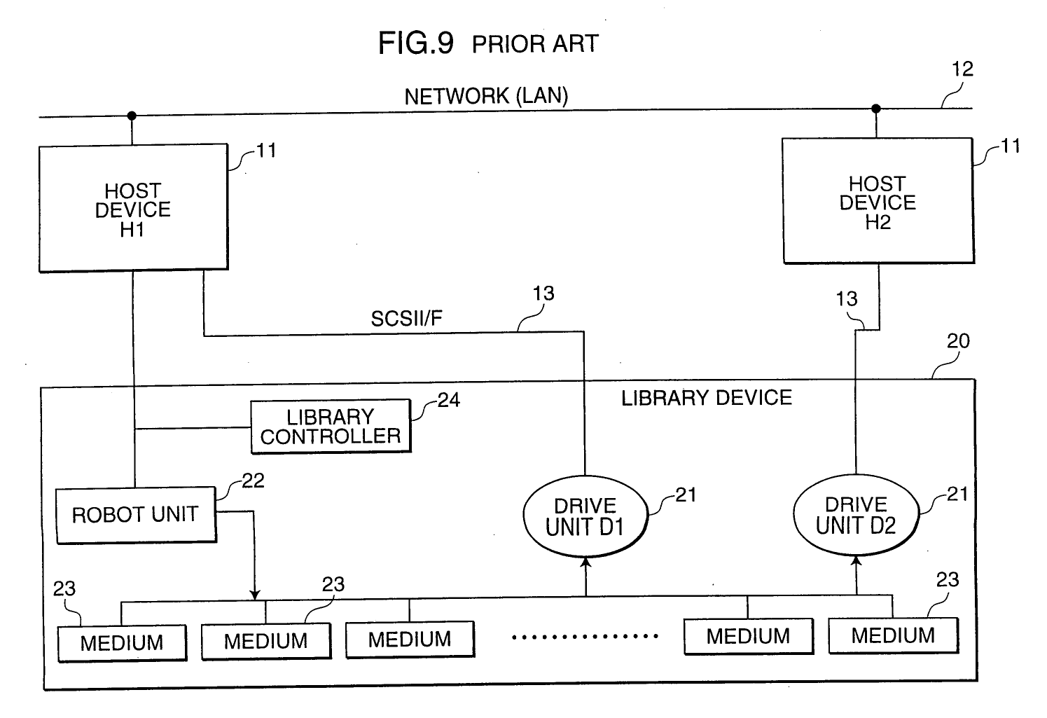

FIG. 10 is a configuration block diagram of a conventional library system.

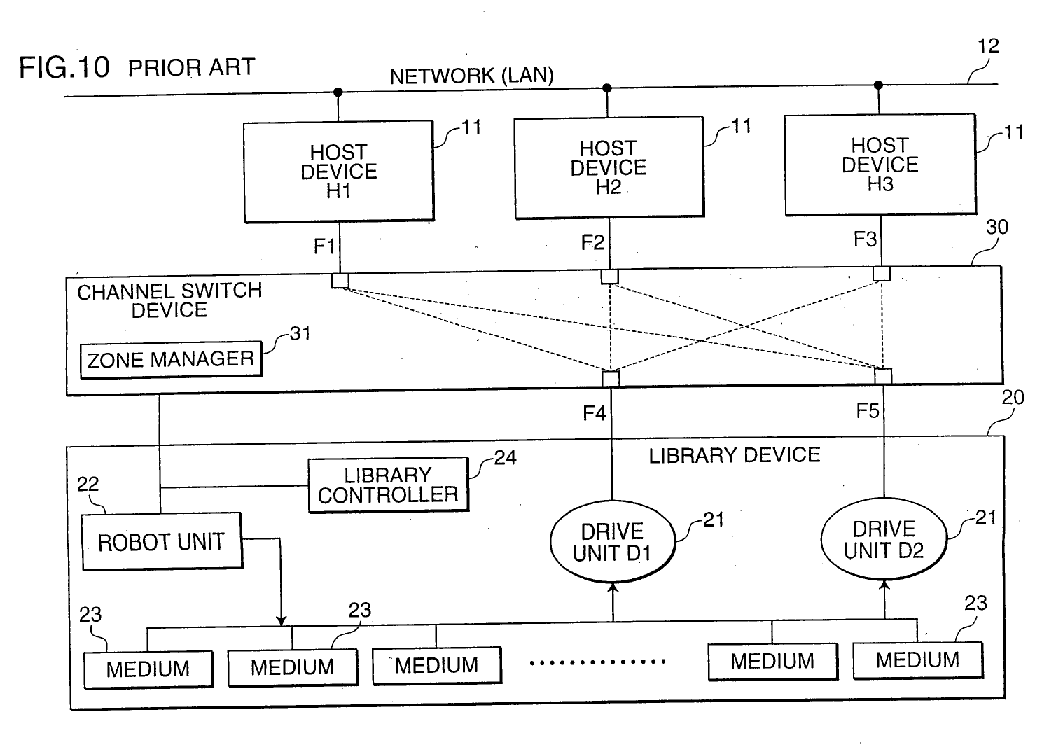

### DESCRIPTION OF THE PREFERRED EMBODIMENTS

Embodiments of the invention will be described below with reference to the drawings. The invention is not limited to the following embodiments.

### First Embodiment

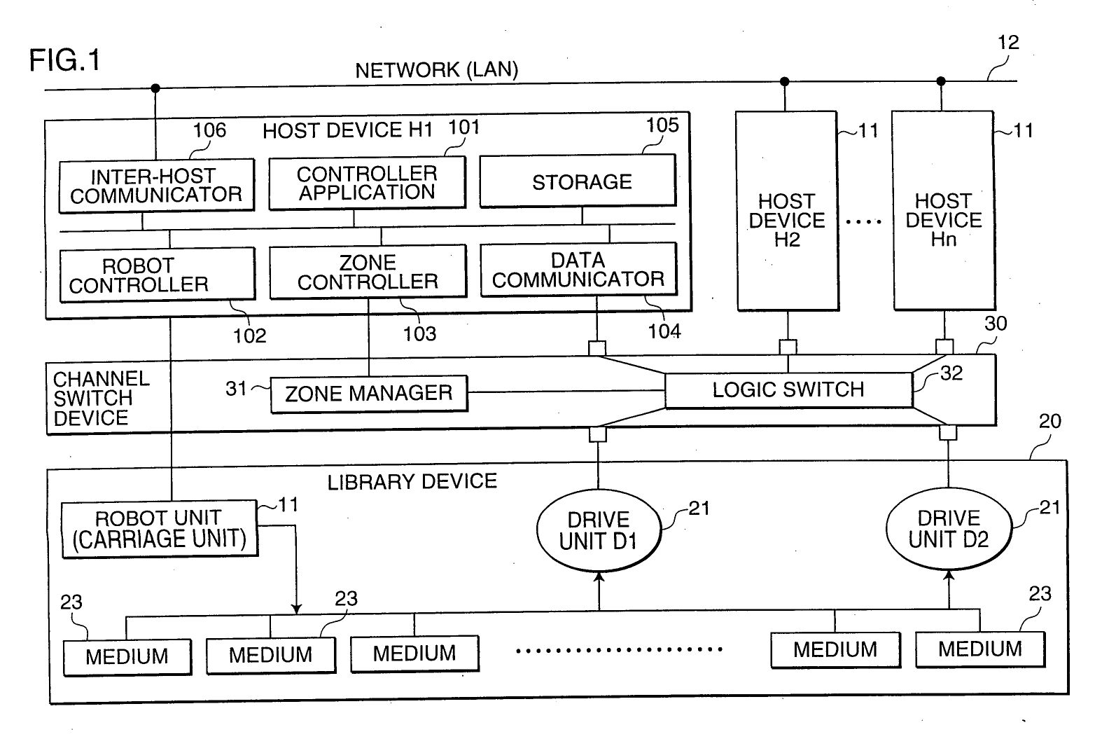

FIG. 1 is a configuration block diagram showing an embodiment of a library control system of the invention.

As shown in FIG. 1, the library control system of the invention is constructed by host devices (H1, H2, . . . and Hn) 11, a channel switch device 30, and a library device 20.

The plural host devices 11 are connected to each other via a network 12 and transmit/receive data to/from each other. As the network 12, an LAN is used here. Alternatively, a global network such as the Internet can be also used.

The channel switch device 30 is provided between each host device 11 and the library device 20 and is constructed by a zone manager 31 for managing a zone specifying the connection relation between the host device 11 and the drive unit 21, and a logic switch 32 for logically connecting the host device 11 and the drive unit 21 on the basis of a set zone.

The library device 20 houses a number of recording media 23 and includes the robot unit (carriage unit) 22 for carrying a requested recording medium 23 and inserting it to the drive unit 21.

The recording media 23 are any storage media including rewritable recording media such as a magnetic tape cartridge, a magnetic disk, and a magneto-optic disk and read-only recording media such as a CD-ROM.

In the following embodiment, a tape will be used as a representative of the recording media.

The robot unit 22 and the drive units 21 which are the same as those used in the conventional library device can be used. The number of drive units 21 is not limited to two as shown in the diagram but is determined according to the scale of the library device 20, an access request specification, and the like. The drive units 21 may be added or deleted as necessary.

The host device 11 is constructed mainly by a controller 101, a robot controller 102, a zone controller 103, a data communicator 104, a storage 105, and an inter-host communicator 106.

The controller 101 is a main part which allows the functions to be executed by the host device 11, and realizes a desired function by making another function block organically operated on the basis of an application program stored in the storage 105.

For example, the controller 101 can be realized by a microcomputer constructed by a CPU, a ROM, a RAM, an I/O controller, a timer, and the like.

In particular, in the invention, the controller 101 executes a process of recording/reproducing data to/from the library device 20. When the recording/reproducing process is performed, the controller 101 gives an instruction to the robot controller 102, zone controller 103, and data communicator 104.

In the invention, the application program denotes a program including the function of requesting the library device 20 to perform recording/reproduction. For example, a user data backup program and a library device information search program correspond to the application programs.

The robot controller 102 is a part for controlling the robot unit 22. For example, the robot controller 102 sends control information such as a tape carriage instruction to the robot unit 22 and receives a tape carriage end notification from the robot unit 22. The zone controller 103 is a part for transmitting a zone setting instruction information to the zone manager 31 and receiving a zone setting completion notification from the zone manager 31. As will be described later, each time a request for accessing the library device 20 is generated from the application program, the zone setting instruction is sent to the zone manager 31, and the zone manager 31 checks setting of the zone, and sets the connecting relations between the host devices 11 and the drive units 21.

The data communicator 104 is a part for writing/reading data to/from the medium 23 after zones are set and the medium 23 is set in the drive unit 21. Data is transmitted through a path set by a logic switch 32 and transferred to the medium 23 set in the drive unit 21 or read from the medium 23 via the path in reverse.

The storage 105 is a part for storing an application program to be executed by the host device 11, data generated by the user, or data necessary for robot control, zoning control, data communication and the like. As the storage 105, a semiconductor memory such as a ROM or a RAM, a hard disk, a flash memory, or the like is used.

The zone manager 31 in the channel switch device 30 is a part for setting zones. Specifically, the zone manager 31 is a part for managing the number of a port to which the host device 11 and the drive unit 21 are connected and dynamically setting the connecting relation between the host device 11 and the drive unit 21 and has a memory such as a RAM for storing set information as zone management information.

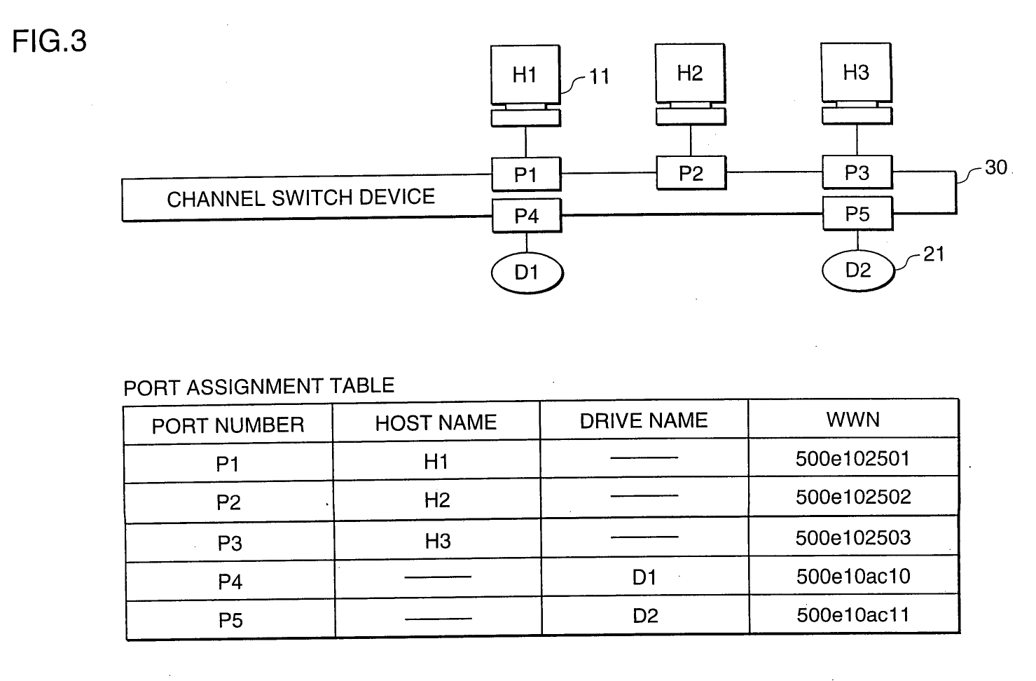

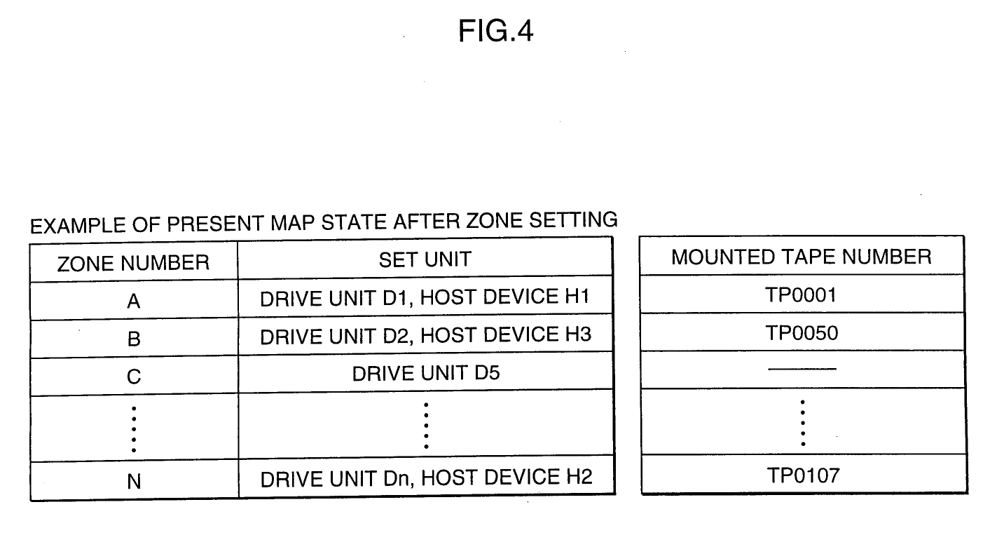

Examples of the management information are a port assignment table shown in FIG. 3 and present zone map information shown in FIG. 4.

FIG. 3 shows an example of a port assignment table as the zone management information of the invention.

FIG. 3 shows five ports (P1 to P5). The invention, however, is not limited to five ports but an arbitrary number of ports can be provided on the basis of a design specification. To each port, one device is connected. Information showing connections between devices and ports is stored as a table shown in FIG. 3.

The table can be manually input at the time of system configuration. Alternatively, the channel switch device 30 may check connection between each port and a device by polling operation every predetermined time and automatically collect information of the table. Host names and drive names may be collected and stored into a table, or the name WWN (World Wide Name) peculiar to a fiber channel to which a host device and a drive unit are connected may be also collected and stored.

The table of FIG. 3 shows that, for example, the host device 11 having the host name “H3” and having WWN “500e102503” is connected to the port P3.

FIG. 4 shows an example of zone map information of the invention.

The “zone” denotes a group of a host device 11 and a drive unit 21 to which an actual access is permitted among a number of host devices 11 and drive units 21 connected to the channel switch device 30.

For example, when two zones A and B are set, data can be read and written between host devices and drive units in the same zone (zone A or B) but the host device and drive unit cannot access to other zones.

In the example of FIG. 4, four zones having zone numbers A, B, C and N are shown. The zone having the zone number A is set that the drive unit D1 and the host device H1 belong to the same group.

In the zone having the zone number B, the drive unit D2 and the host device H3 are grouped. In the zone having the zone number N, the drive unit Dn and the host device H2 are grouped.

The zone having the zone number C is set only by one drive unit D5.

In the case where the zones are set as described above, the host device H1 belonging to the zone A can make a read/write access to the drive unit D1 but cannot access the drive unit D2 belonging to the zone B and the drive unit D5 belonging to the zone C.

Similarly, the host device H3 belonging to the zone B cannot access the drive unit D1 belonging to the zone A, the drive unit D5 belonging to the zone C, and the drive unit Dn belonging to the zone N.

The state of the zone map shown in FIG. 4 is not fixedly preset at the time of start. In the invention, each time some access request (for example, data write request) is sent from the host device 11 to the library device 20, the state is set dynamically.

Therefore, for example, when zone setting is already made so that the drive unit D1 is used by the host device H4, the zone map like the zone A in FIG. 4 cannot be generated. When an access request is sent from the host device H1, a drive unit (for example, D7) which is not used by any host device is assigned, and a zone map different from that of FIG. 4 is created.

Since a zone map is dynamically set in consideration of the connecting relations between the present host devices 11 and the drive units 21 as described above, hardware resources such as the drive units 21 can be effectively utilized, data loss and destruction can be prevented, and security of the library control system can be enhanced.

When the number of host devices or drive units connected to the system increases, decreases or changes in the case where zones are fixedly preset, the user makes resetting and the system has to be temporarily stopped. However, according to the invention, even if such increase, decrease, or change occurs, the setting is made dynamically each time. Thus, the user does not have to check setting, zone setting can be made easily and promptly, and it is unnecessary to stop the system.

The logic switch 32 in the channel switch device 30 is a part which logically connects the host device 11 and the drive unit 21 which are subjected to zone setting but does not set a physical path unlike an exchange.

For example, in the case where there are the drive unit D1 and the host device H1 which are set in the zone A, the logic switch 32 refers to a zone map set by the zone manager 31 and sends data transmitted from the data communicator 104 of the host device H1 to the drive unit D1 belonging to the same zone A.

Physical connection between a host device and the channel switch device 30 is made via one port. In FIG. 1, the zone controller 103 and the zone manager 31 may be connected to each other via an independent cable (such as RS-232C) or a LAN.

Similarly, the robot controller 102 and the robot unit 22 may be connected to each other by using an independent dedicated connection as shown in the diagram or an LAN.

An example of dynamic zone setting of the invention will now be described.

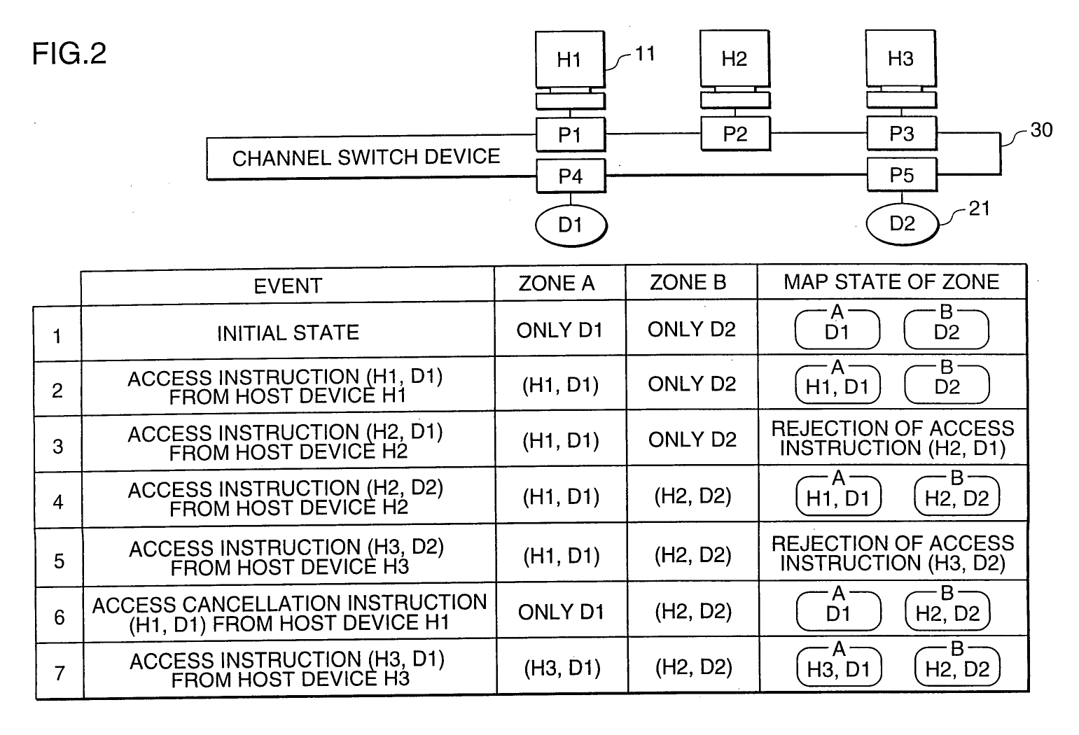

FIG. 2 is an explanatory diagram showing zone setting and a zone map state.

It is assumed that seven events 1 to 7 occur in this order in FIG. 2. The zones A and B and the zone map state show the states of zones changing in the seven events.

In this case, an example in which three host devices (H1, H2, and H3) and two drive units (D1 and D2) are connected to the channel switch device 30 will be described.

First, the event 1 shows an “initial state”. In this example, a state where no access request is sent from the host device is shown. Only the drive unit D1 belongs to the zone A and only the drive unit D2 belongs to the zone B. In this state, the two drive units 21 cannot be accessed by any of the host devices 11.

Next, it is assumed that an access instruction is sent from the host device H1 to the library device 20 (event 2).

The access instruction includes information such that data is to be written into a predetermined tape medium 23 from the host device H1 by using the drive unit D1.

As the flow of the access instruction, the access instruction is sent from the controller 101 of the host device H1 to the zone controller 103 and is then sent to the zone manager 31.

The zone manager 31 checks the information included in the access instruction and the present zone map state, and determines whether the host device H1 and the drive unit D1 can belong to the same zone or not.

In the initial state of FIG. 2, only the drive unit D1 belongs to the zone A. In the state of the event 2, as the zone A, a zone to which the drive unit D1 and the host device H1 belong is set.

Therefore, in the event 2, the zone map is constructed by the zone A to which the host device H1 and the drive unit D1 belong and the zone B to which only the drive unit D2 belongs.

In this state, the host device H1 and the drive unit D1 can freely access each other. However, even if an access is made by erroneous operation or the like from the other host device H2 or H3 to the drive unit D1, the access is rejected.

Therefore, while the host device H1 is accessing the tape medium 23 mounted in the drive unit D1, an access to the tape medium 23 from another host device H2 is inhibited. Thus, destruction and loss of data is prevented.

It is assumed that an access instruction (H2, D1) from the host device H2 to the drive unit D1 is generated in the event 3. Since the zone of “drive unit D1 and host device H1” is already set as the zone A, the access instruction (H2, D1) is rejected.

It is now assumed that an access instruction (H2, D2) is sent from the host device H2 to the drive unit D2 in the event 4.

Since no host device is included in the zone B to which the drive unit D2 belongs, the zone manager 31 newly sets a zone of “host device H2 and drive unit D2” as the zone B. It enables data communication to be performed between the host device H2 and the drive unit D2.

In the case where the zones A and B are set in such a manner, an access between the zones is not permitted. Consequently, even if an access request to the drive unit D2 belonging to the zone B is sent from the host device H1 belonging to the zone A, the access request is rejected.

Even if there is an access instruction (H3, D2) is sent from the host device H3 which does not belong to any zone to the drive unit D2 in the event 5, the access instruction (H3, D2) is rejected.

It is now assumed that an access cancel instruction (H1, D1) is sent from the host device H1 in the event 6. When the zone manager 31 recognizes the access cancel instruction, the zone A is reset to the zone to which only the drive unit D1 belongs. The zone A is reset to the initial state and an access from the host device H1 to the drive unit D1 is cancelled.

It is now assumed that an access instruction (H3, D1) is generated from the host device H3 in the event 7. By this time, the zone A is reset to the initial state, so that the access instruction of the host device H3 can be accepted. As the zone A, the zone of “host device H3 and drive unit D1” is set.

Although the host device H3 can access the drive unit D1 and the host device H2 can access the drive unit D2 in the state of the event 7, even if an access instruction is sent from the host device H1 to the drive unit D1 or D2, the access instruction is rejected.

The flow of a general access process of the library system of the invention will now be described. Although the case where a data write instruction is generated will be described as an example, the flows of other accesses such as a data read access are almost the same.

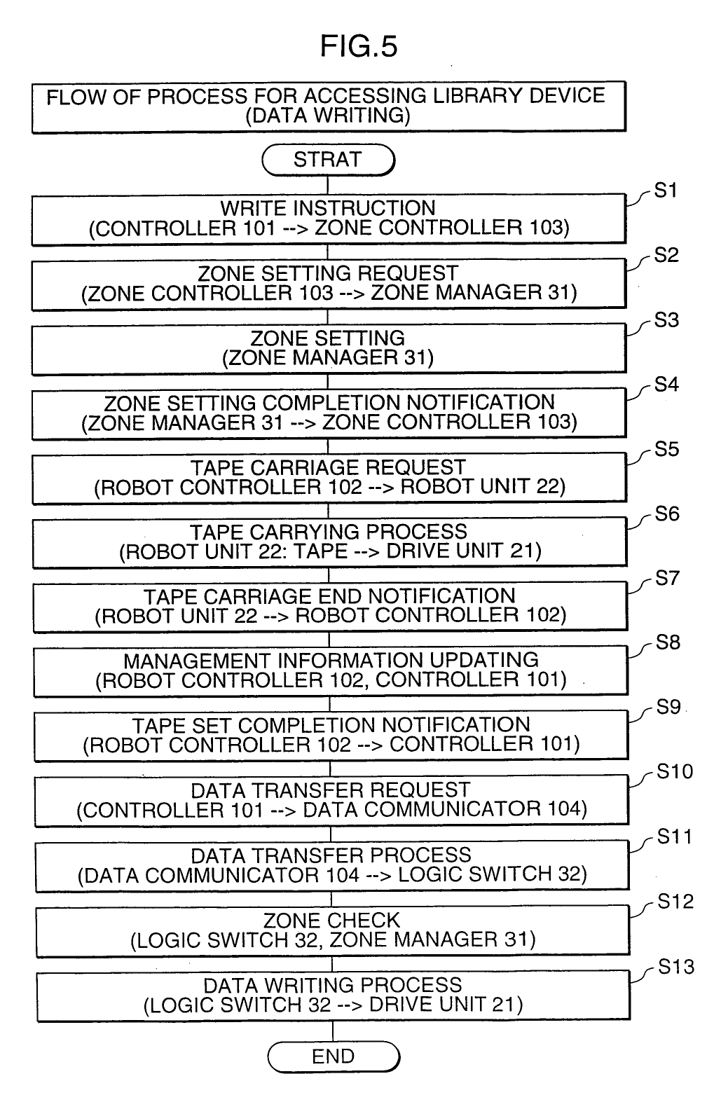

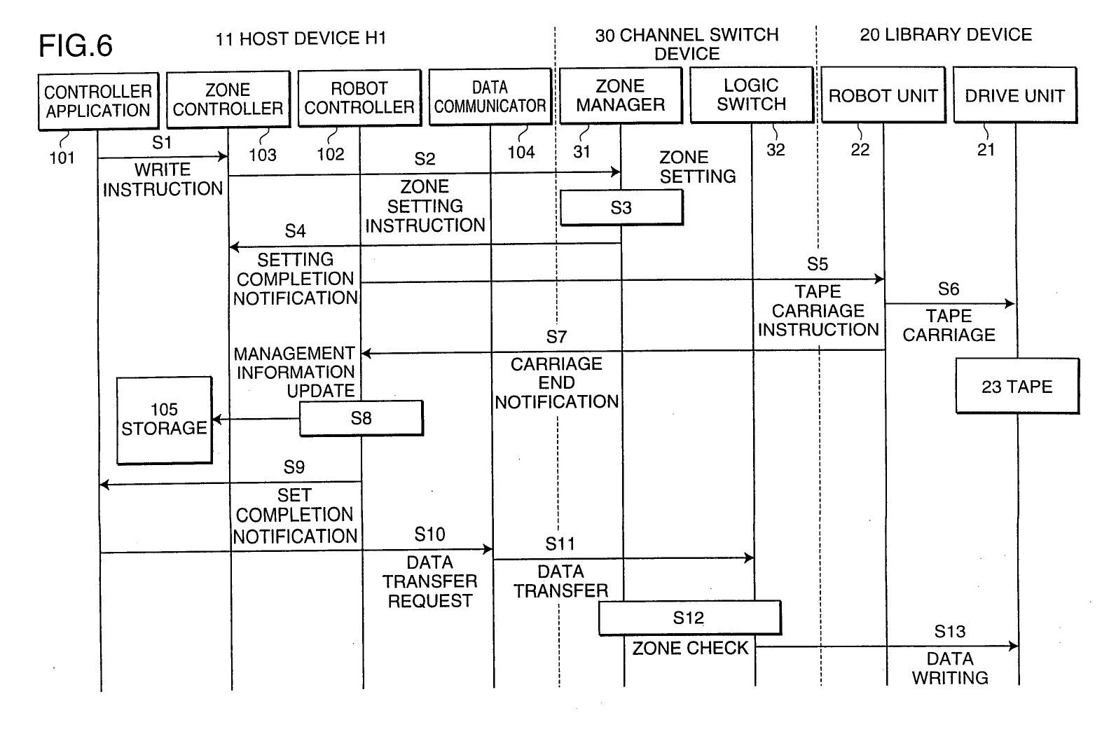

FIG. 5 is a flowchart showing a process of accessing the library device. FIG. 6 shows an example of the flow of data in the whole library system. The same step numbers (S1 to S13) are used in FIGS. 5 and 6.

First, a write instruction S1 is sent from the application program (controller) 101 of the host device H1 to the zone controller 103 (step S1). The write instruction includes at least the host device identification number (H1), drive unit identification number (D1), and tape medium identification number (T1). As each of the identification numbers, not only the name but WWN can be used.

In step S2, the zone controller 103 which has received the write instruction sends a zone setting instruction S2 to the zone manager 31 in the channel switch device 30.

The zone setting instruction S2 includes at least the host device number (H1) and the drive unit number (D1).

The zone controller 103 which has received the zone setting instruction S2 makes zone setting. The zone setting is performed each time an event occurs as shown in FIG. 2.

Although a new zone including a host device can be set for a zone to which only one drive unit belongs, in the case where there is already a zone to which a host device and a drive unit belong, setting to make a new host device belong to the zone is not made. That is, by setting zones under condition that two host devices are not allowed to belong to one zone, safety of data and prevention of destruction can be made certain.

At the time of making zone setting, the zone manager 31 stores the present map state as shown in FIG. 4 as management information.

When the zone setting is completed in step S3, the zone manager 31 sends a zone setting completion notification to the zone controller 103 (step S4).

When a zone cannot be set, a zone setting rejection notification is sent.

In step S5, the controller 105 sends a tape carriage instruction to the robot unit 22 via the robot controller 102.

The tape carriage instruction includes the host device identification number (H1), drive unit identification number (D1), and tape identification number (T1).

In step S6, the robot unit 22 carries the requested tape (T1) 23 to the requested drive unit (D1) and mounts it.

In step S7, when the tape (T1) is mounted in the drive unit D1, the robot unit 22 sends a tape carriage end notification to the robot controller 102.

In step S8, management information is recorded on the storage 105. In step S9, the robot controller 102 notifies the controller 101 of the mounting of the requested tape into the requested drive unit (setting completion notification).

Also in this case, management information as shown in FIG. 4 is recorded. The management information recorded in the storage 105 may include “the number of a mounted tape” as shown in FIG. 4.

In step S10, the controller 101 sends a data transfer request to the data communicator 104.

In step S11, the data communicator 104 adds control information including the host device identification number (H1), drive unit identification number (D1), and tape identification number (T1) to data to be written and transfers the resultant to the logic switch 32.

The logic switch 32 refers to the zone map set by the zone manager 31 and checks whether the given identification number of the drive unit matches the drive unit set in the zone or not (step S12).

When the zone check finishes normally, the program advances to step S13 and data is written to the tape 23 set in the drive unit 21.

The flow of the data writing process has been described above.

In the case of finishing of writing, temporary stop of writing, and cancellation of an access process for some reason such as a fault, it is sufficient to send a write finish instruction, an interruption instruction, an access cancellation (reset) instruction, or the like from the controller 101 to the zone controller 103, data communicator 104, and robot controller 102.

By dynamically making zone setting each time an access request such as a write instruction is generated, the drive unit can be effectively used, exclusive control can be performed without destroying data, and sufficient security can be assured.

### Second Embodiment

A recovery process performed when the host device is down will now be described.

In this case, two host devices (H1, H2) are set so that the same process can be performed. Normally, the host device (H1) as one of the host devices operates and the other host device (H2) is allowed to operate as a spare when the host device (H1) stops.

For example, when the host device (H1) performs a process of writing data to the drive unit D1 in the library device 20 and becomes inoperable due to some fault, the host device H2 automatically starts up in place of the host device (H1), and the host device (H2) continues the writing process on the drive unit D1.

In the system shown in FIGS. 1 and 2, an access can be made only between the host device 11 and the drive unit 21 which are set in the same zone and the other host devices outside of the zone cannot access the drive unit 21. Consequently, once the host device H1 and the drive unit D1 are set in the same zone, the drive unit D1 cannot be accessed from another host device H2.

In other words, a situation such that the drive unit D1 is continuously occupied and is not permanently released occurs.

The state where the drive unit D1 cannot be accessed by another host device H2 continues as long as the zone is effectively set irrespective of whether the host device H1 operates normally or not. In the embodiment, when the host device H1 becomes abnormal, the zone setting of the host device H1 is cancelled and the zone is switched to a new zone to which the host device H2 and the drive unit D1 belong.

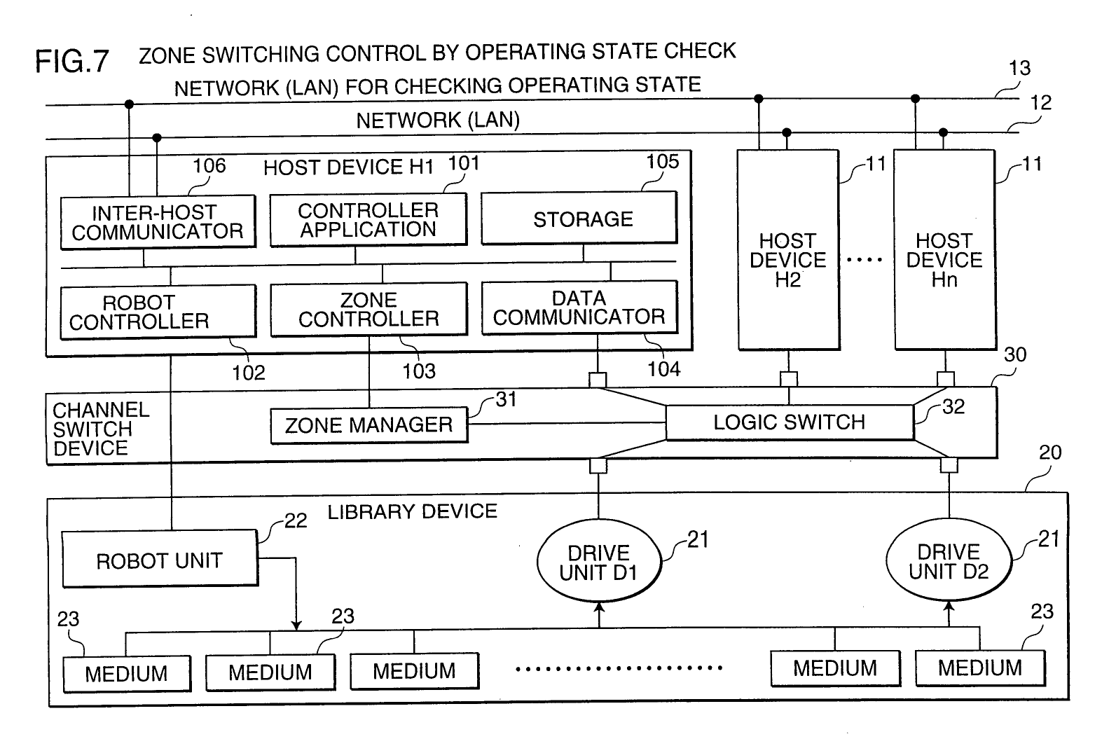

FIG. 7 is a configuration block diagram of a library system in zone switching control of the invention.

Different from FIG. 1, the network (LAN) 13 for checking an operating state is provided separately from the network 12. To the network 13, information of a state of a host device, which is periodically sent from the host device to another host device is sent.

By periodically receiving the information indicative of the state of the host device (H1) via the network 13, the another host device (H2) can know that the host device (H1) normally operates.

In other words, by detecting that periodical information cannot be received, the host device (H2) can know that the host device (H1) becomes abnormal and does not operate.

It is assumed that the host device H2 prepared as a spare system of the host device H1 always obtains operation information of the host device H1 and, for example, grasps the drive unit 21 which is presently used by the host device H1 and the access process presently performed.

Such operation information may be obtained via the network 12 by the host communicator 106.

When a zone switch request is received, the zone manager 31 in the channel switch device 30 performs a process of temporarily switching the present zone to a zone for maintenance.

The zone for maintenance denotes a zone obtained by switching the host device belonging to the presently set zone to another host device.

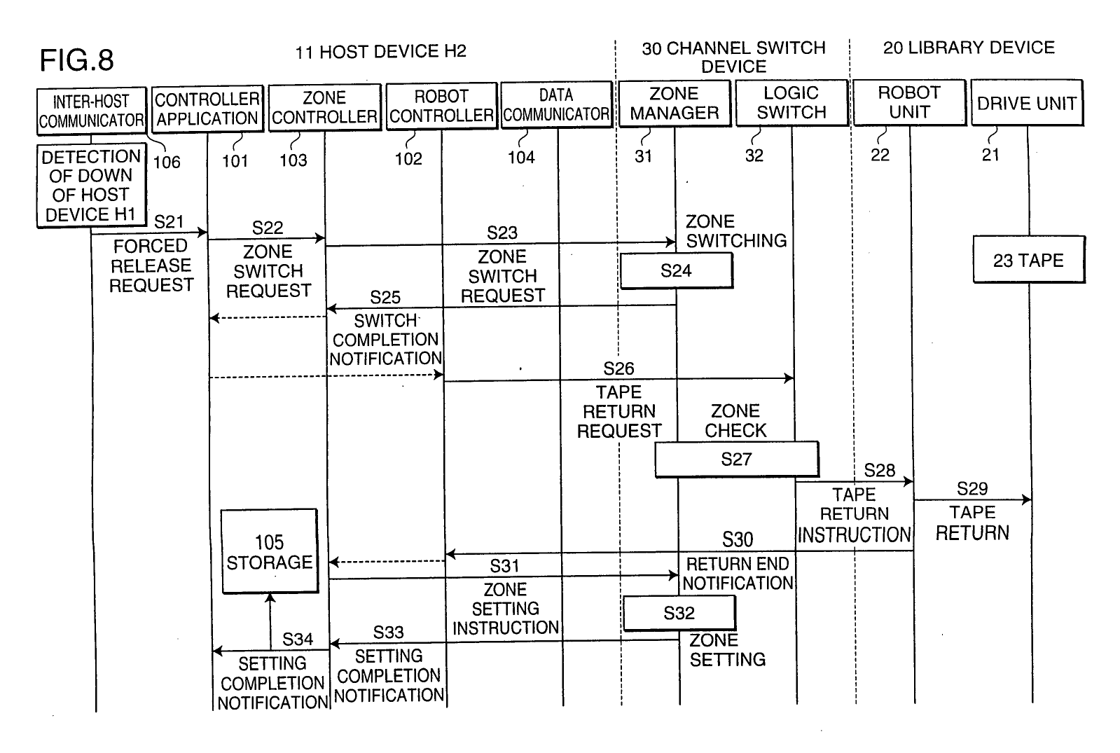

FIG. 8 is an explanatory diagram showing the flow of the zone switching process of the invention.

First, when data communication periodically performed between the host devices H1 and H2 is interrupted and down of the host device H1 is detected by the host communicator 106 of the host device H2, a forced release request is transmitted to the controller 101 (step S21).

Since the host device H2 knows the present operating state of the host device H1, the host device H2 sends a request for switching the zone of the host device H1 to the zone controller 103 (step S22).

The zone switch request includes the host device identification number (H1) to be switched, the drive unit identification number (D1) used by the host device, and the tape identification number (T1).

In step S23, the zone controller 103 sends a zone switch instruction to the zone manager 31 of the channel switch device 30.

The zone manager 31 which has received the zone switch instruction performs a zone switching process (step S24).

It is assumed that the zone switching instruction (S23) includes the host device identification number (H1) used before the switching and the host device identification number (H2) after the switching. The zone manager 31 checks the zone to which the host device H1 before the switching is presently assigned with reference to the zone map and changes the setting of the zone to the host device identification number (H2) switched from the host device H1.

Specifically, when the host device H1 and the drive unit D1 are assigned to the zone A before the switching, the setting of the zone A is changed so that the host device H2 and the drive unit D1 belong to the zone A and the resultant setting is stored. The zone A obtained by the change is the zone for maintenance.

In the state of the zone for maintenance, only the host device H2 belonging to the zone A can access the drive unit D1.

Therefore, the drive unit D1 which has been dedicated to the host device H1 and cannot be accessed by any host devices at present is released only to the host device H2 and is changed to the state where the drive unit D1 cannot be accessed by the other host devices.

By performing such switching process, the process of canceling only the inoperable zone is executed and no influence is exerted to accesses to zones which normally operate. Since the cancellation of one inoperable zone does not exert an influence on the other zones, security is assured and the operation of the channel switch device can be effectively continued.

After completion of the zone switching, the zone manager 31 sends a switching completion notification to the zone controller 103 (step S25).

When the zone controller 103 recognizes completion of the switching, the completion is notified to the controller 101 or robot controller 102, and a tape return request is sent from the robot controller 102 to the logic switch 32 (step S26).

The tape return request includes the host device identification number (H2), drive unit identification number (D1), and tape identification number (T1).

In step S27, a check is made to see whether the tape return request is acceptable or not.

Whether the tape return request is acceptable or not is checked by using the zone map of the zone manager 31. At present, since the zone A was switched to the zone for maintenance in step S24, a check is made to see whether or not the host device identification number (H2) and the drive unit identification number (D1) requesting for return of the tape matches the information (host device H2 and drive unit D1) of the zone A which is set and stored as the zone for maintenance.

If the information does not match, the tape return request is rejected. If the information matches, the tape return request is handled as effective one and a tape return instruction is sent to the robot unit 22 (step S28).

The robot unit 22 which has received the tape return instruction executes a process of returning the tape to the drive unit D1 in step S29. Specifically, the robot unit 22 takes out the tape 23 in the drive unit D1 instructed by the instruction and carries it to the original storage position.

After returning the tape, a return end notification is sent to the robot controller 102 (step S30).

The end notification is also sent to the zone controller 103, and the zone controller 103 sends a zone setting instruction to the zone manager 31 in order to release the zone A which is presently the zone for maintenance to the initial state (step S31).

In step S32, the zone manager 31 changes setting of the zone A for maintenance. In this case, the zone A is reset to the zone to which only the drive unit D1 belongs. In other words, the host device H2 is deleted from the zone map of the zone A. By the operation, the zone A becomes the zone to which only the drive unit D1 belongs. Consequently, when an instruction for accessing the drive unit D1 is sent from another host device 11, the instruction is accepted, zone setting is made, and an access using the drive unit D1 is enabled.

By such a process, only a troubled drive unit among the number of drive units 21 connected to the channel switch device 30 can be reset, the other drive units remain in their connection states and continue the operations, and the troubled drive unit also becomes accessible.

After completion of such zone setting, a setting completion notification is sent from the zone manager 31 to the zone controller 103 (step S33).

The zone setting completion notification is also sent to the controller 101 and management information such as the present zone map in the storage 105 is updated (step S34).

The flow of the zone switching process performed when one host device is down has been described above.

By performing the zone switching as described above, exclusive control which does not cause data loss in a zone where a trouble occurs is executed and highly reliable security is maintained. Without exerting an adverse influence to the other normal zones, only the troubled zone can be recovered.

According to one or more embodiments of the invention, a zone specifying a range which can be accessed by a host device is dynamically set for a drive unit in the library device. Consequently, hardware resources such as drive units can be effectively utilized and exclusive control on a drive unit during an access to the drive unit by a host device is performed more perfectly, so that security in the case where the library device is shared by plural host devices can be improved.

What is claimed is:

1. A library control system comprising
a library device for storing plural recording media,
plural host devices for requesting for an access to the recording media and
a channel switch device for controlling connection between the plural host devices and the library device, wherein
the library device has
plural drive units for accessing a mounted recording medium and
a carriage unit for carrying a requested recording medium to a desired drive unit;
the channel switch device has
a logic switch for connecting the plural host devices and the plural drive units in accordance with a predetermined zone map, and
a zone manager for setting the zone map;
each of the plural host devices has a controller for transmitting a request of access to the library device, and
a zone controller for requesting the zone manager to set a zone map each time the access request is sent from the controller;
and wherein when the zone controller requests the zone manager to set a zone map, the zone manager sets a zone map so that one of the plural drive units and one of the plural host devices belong to one zone and another host device does not belong to the zone to which the one drive unit and the one host device already belong.

2. The library control system according to claim 1, wherein
each of the host devices further has an inter-host communicator for performing periodic communication with other host devices,
and wherein in case where two of the plural host devices (H1 and H2) are connected to the channel switch device, a first host device H1 has already accessed a recording medium mounted on a drive unit D1 in the library device, and the zone manager sets a zone map to which the first host device H1 and the drive unit D1 being accessed belong,
when the inter-host communicator of a second host device H2 detects that the first host device H1 is in an interrupted state, the zone controller of the second host device H2 sends a request for releasing the zone map to the zone manager, and the controller sends a request for releasing the recording medium from the drive unit D1 included in the zone map to the carriage unit.

3. The library control system according to claim 1, wherein
in the case where the zone manager sets a zone including only a first drive unit and a first host device, the logic switch rejects the access request, even when an access request to the first drive unit is received from a host device other than the first host device.

4. The library control system according to claim 1, wherein
the zone manager initially sets a zone map so that only one drive unit is included in one zone.

5. The library control system according to claim 2, wherein
the request for releasing the zone map is a zone switch instruction for switching the first host device H1 to the second host device H2 in the zone including the first host device H1.

6. A library control system comprising
plural host devices for requesting for an access to a library device storing plural drive units for accessing a mounted recording medium and a channel switch device for controlling connection between the plural host devices and the library device, wherein
the channel switch device has
a logic switch for connecting the plural host devices and the plural drive units in accordance with a predetermined zone map, and a zone manager for setting the zone map;
at least one of the plural host devices has
a controller for transmitting a request of access to the library device, and a zone controller for requesting the zone manager to set a zone map each time the access request is received from the controller;
and wherein when one of the plural host devices requests for an access to the library device, a zone map is set so that one of the plural drive units and the one of the plural host devices belong to one zone and another host device does not belong to the zone to which the one drive unit and the one host device already belong.

7. The library control system according to claim 6, wherein
each of the host devices further has an inter-host communicator for performing periodic communication with other host devices, and
wherein in case where the plural host devices constructed to perform communications using the inert-host communicator are connected to the channel switch device, a first host device H1 has already accessed a recording medium mounted on a drive unit D1 in the library device, and the zone manager sets a zone to which the first host device H1 and the drive unit D1 belong in a zone map,
when the inter-host communicator of a second host device H2, which is one of the plural host devices other than the first host device, detects that the first host device H1 is in an interrupted state,
the zone controller of the second host device H2 sends a request for releasing the zone including the first host device H1 and the drive unit D1 to the zone manager.

8. A library device control method of a library control system comprising a library device, plural host devices for requesting for an access to the library device storing plural drive units for accessing a mounted recording medium and a channel switch device for controlling connection between the plural host devices and the library device, wherein
when one of the host devices requests for an access to the library device, the channel switch device accepts the access request and, after that, a zone map is set so that one of the plural drive unit and the one of the plural host devices belong to one zone and another host device does not belong to the zone to which the one drive unit and the one host device already belong.

9. The library device control method according to claim 8, wherein
the channel switch device has a zone manager for setting a zone map including the plural host devices and the plural drive units,
at least one of the plural host devices has a zone controller for requesting the zone manager to set a zone map each time an access request for the library device is received,
each of the plural host devices has an inter-host communicator for performing periodic communication with other host devices,
in case where the plural host devices constructed to perform communications using the inert-host communicator are connected to the channel switch device, a first host device H1 has already accessed a recording medium mounted on a drive unit D1 in the library device, and the zone manager sets a zone to which the first host device H1 and the drive unit D1 belong in a zone map,
when the inter-host communicator of a second host device H2, which is one of the plural host devices other than the first host device, detects that the first host device H1 is in an interrupted state,
the zone controller of the second host device H2 sends a request for releasing the zone including the first host device H1 and the drive unit D1 to the zone manager.
